(19) United States
(12) Patent Application Publication
(10) Pub. No.: US 2026/0288651 A1
(43) Pub. Date: Sep. 24, 2026

(54) METHOD, APPARATUS, DEVICE AND STORAGE MEDIUM FOR DATA PROCESSING

(71) Applicants: Beijing Volcano Engine Technology Co., Ltd., Beijing (CN); Southern University of Science and Technology, Shenzhen, Guangdon (CN)

(72) Inventors: Peixuan HE, Beijing (CN); Weili WANG, Beijing (CN); Yinqian ZHANG, Shenzhen, Guangdong (CN); Honghan JI, Beijing (CN); Yao ZHANG, Beijing (CN); Ye WU, Beijing (CN)

(21) Appl. No.: 19/479,980

(22) PCT Filed: Jul. 30, 2024
(86) PCT No.: PCT/CN2024/108590

§ 371 Date: Oct. 29, 2025

(30) Foreign Application Priority Data
Aug. 2, 2023 (CN) 202310967247.X

(51) Int. Cl. G06F 12/109

(52) U.S. Cl. CPC G06F 12/109; G06F 2212/657

(57) ABSTRACT

Embodiments of the present disclosure provide a method, an apparatus, a device, and a storage medium for data processing. The method includes: initializing a first program and a second program different from the first program in a trusted execution environment; allocating a first memory space and a second memory space to the first program and the second program respectively, where the first memory space is a linear memory address space and includes at least a first memory page; and where the second memory space is a linear memory address space and includes at least a second memory page; mapping the first memory page of the first memory space to a first virtual memory page in a virtual address space of the trusted execution environment; and mapping the second memory page of the second memory space to the first virtual memory page in the virtual address space.

The present application claims benefit of Chinese Patent Application No. 202310967247.X, filed on Aug. 2, 2023 and entitled “METHOD, APPARATUS, DEVICE AND STORAGE MEDIUM FOR DATA PROCESSING”, which is incorporated herein by reference in its entirety.

### FIELD

Example embodiments of the present disclosure generally relate to the field of computer, and in particular, to a method, an apparatus, a device, and a computer-readable storage medium for data processing based on a trusted execution environment.

### BACKGROUND

A trusted execution environment (TEE) constructs a security region in a central processing unit by means of software and hardware, which can provide an independent execution environment with confidentiality and integrity protection for programs running therein. In the trusted execution environment, program running codes and confidential data can be maintained in a piece of encrypted isolated memory, and calculation is completed in the encrypted memory. The whole calculation process is invisible to the outside, so as to realize data protection. In other words, different programs can be run in the trusted execution environment in a manner isolated from each other. While ensuring data security, such isolation also increases the complexity of sharing data between programs. Therefore, how to quickly and efficiently realize memory sharing in the trusted execution environment to realize data sharing between programs is a technical problem to be solved urgently at present.

### SUMMARY

In a first aspect of the present disclosure, a data processing method is provided. The method includes: initializing, in a trusted execution environment, a first program and a second program different from the first program; allocating a first memory space and a second memory space to the first program and the second program respectively, where the first memory space is visible to the first program and invisible to the second program, and the second memory space is visible to the second program and invisible to the first program; where the first memory space is a linear memory address space and includes at least a first memory page; and where the second memory space is a linear memory address space and includes at least a second memory page, and the second memory page is different from the first memory page; mapping the first memory page of the first memory space to a first virtual memory page in a virtual address space of the trusted execution environment; and mapping the second memory page of the second memory space to the first virtual memory page in the virtual address space.

In a second aspect of the present disclosure, a data processing apparatus is provided. The apparatus includes: a program initialization module configured to initialize a first program and a second program different from the first program in a trusted execution environment; a memory allocation module configured to allocate a first memory space and a second memory space to the first program and the second program respectively, where the first memory space is visible to the first program and invisible to the second program, and the second memory space is visible to the second program and invisible to the first program; where the first memory space is a linear memory address space and includes at least a first memory page; and where the second memory space is a linear memory address space and includes at least a second memory page, and the second memory page is different from the first memory page; a first mapping module configured to map the first memory page of the first memory space to a first virtual memory page in a virtual address space of the trusted execution environment; and a second mapping module configured to map the second memory page of the second memory space to the first virtual memory page in the virtual address space.

In a third aspect of the present disclosure, an electronic device is provided. The device includes at least one processing unit; and at least one memory coupled to the at least one processing unit and storing instructions for execution by the at least one processing unit, where the instructions, when executed by the at least one processing unit, cause the electronic device to perform the method according to the first aspect.

In a fourth aspect of the present disclosure, a computer-readable storage medium is provided. The computer-readable storage medium stores a computer program, where the computer program is executable by a processor to implement the method according to the first aspect.

It should be understood that the content described in this content part is not intended to identify key or important features of the embodiments of the present disclosure, nor is it intended to limit the scope of the present disclosure. Other features of the present disclosure will become readily understood through the following description.

### BRIEF DESCRIPTION OF DRAWINGS

The above and other features, advantages, and aspects of the embodiments of the present disclosure will become more apparent when taken in conjunction with the drawings and with reference to the following detailed description. The same or similar reference numbers in the drawings refer to the same or similar elements, where:

FIG. 1 illustrates a schematic diagram of an example environment in which embodiments of the present disclosure can be implemented;

FIG. 2 illustrates a flowchart of a data processing method according to some embodiments of the present disclosure;

FIG. 3 illustrates a block diagram of memory mapping according to some embodiments of the present disclosure;

FIG. 4 illustrates a block diagram of program addresses according to some embodiments of the present disclosure;

FIG. 5 illustrates a flowchart of a shared memory mapping method according to some embodiments of the present disclosure;

FIG. 6 illustrates another block diagram of memory mapping according to some embodiments of the present disclosure;

FIG. 7 illustrates a schematic structural block diagram of a data processing apparatus according to some embodiments of the present disclosure; and

FIG. 8 illustrates a block diagram of an electronic device in which one or more embodiments of the present disclosure can be implemented.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms and should not be interpreted as limited to the embodiments set forth herein. On the contrary, these embodiments are provided for a more thorough and complete understanding of the present disclosure. It should be understood that the drawings and embodiments of the present disclosure are only for purposes of example and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

As used herein, unless explicitly stated, performing a step “in response to A” does not mean that the step is performed immediately after “A”, but may include one or more intermediate steps.

It should be understood that data involved in the technical solution (including but not limited to the data itself, acquisition or use of the data) should comply with requirements of corresponding laws and regulations and related provisions.

It should be understood that before using the technical solution disclosed in the embodiments of the present disclosure, the user should be informed of the type, use scope, use scene, etc. of the personal information involved in the present disclosure through an appropriate manner according to relevant laws and regulations, and the authorization of the user should be obtained.

For example, in response to receiving an active request from a user, prompt information is sent to the user to explicitly prompt the user that the operation requested to be performed will require acquisition and use of personal information of the user. Therefore, the user can independently choose whether to provide personal information to software or hardware such as an electronic device, an application, a server or a storage medium that performs the operation of the technical solution of the present disclosure according to the prompt information.

As an optional but non-restrictive embodiment, the manner of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide personal information to the electronic device.

It should be understood that the above process of notifying and acquiring user authorization is only illustrative, and does not constitute a limitation to the embodiments of the present disclosure, and other manners that satisfy relevant laws and regulations may also be applied to the embodiments of the present disclosure.

In recent years, virtual machine technology has been widely used. In order to optimize the processing of a virtual machine, a binary instruction set suitable for a virtual machine scenario is proposed, that is, WebAssembly (which is abbreviated as Wasm in the present disclosure).

The Wasm technology has good isolation. Specifically, multiple Wasm programs can be executed simultaneously in a virtual machine based on the Wasm technology. Each Wasm program has its own independent linear memory address space. In this case, each Wasm program can only access data within its own linear memory address space, and cannot observe or interfere with execution flows and data flows of other Wasm programs.

In addition, the Wasm technology belongs to a lightweight instruction set. Specifically, the Wasm program has the characteristics of small volume, fast cold start, and low consumption of system resources. Further, the Wasm technology has good portability and can be used as a compilation target for other high-level languages. Specifically, the Wasm instruction is a binary format and does not limit the development language. In this case, a program written in a high-level language can be compiled into Wasm bytecode to be run in a Wasm virtual machine. Currently, languages with relatively mature support for Wasm instructions include C, C++, Rust, etc.

Since the Wasm technology belongs to a lightweight instruction set and has good portability and isolation, in addition to browser scenarios, the Wasm technology is increasingly used in application scenarios that require support for programs of multiple languages and multiple tenants.

However, while the good isolation of the Wasm technology enhances data security, it also makes data exchange between Wasm programs more complicated. As discussed above, when a Wasm program is running, each Wasm program can only access its own linear memory address space, but cannot access any area outside its own linear memory address space. Under such a limitation, if two Wasm programs want to exchange data, they can usually only copy data from the linear memory address space of one Wasm program to the linear memory address space of the other Wasm program by means of memory copying, which results in very low efficiency of data exchange between Wasm programs.

In some embodiments, the shared memory can be realized by means of a memory remapping technology to improve the efficiency of data exchange. Specifically, the memory remapping technology refers to remapping a physical memory space pointed to by a virtual address to another physical memory space by changing an address translation process of an operating system. For example, a virtual address VA_1 originally points to a physical address PA_1, and the virtual address VA_1 can be remapped to point to a physical address PA_2. In this way, the program can access the physical address PA_2 by accessing VA_1.

In some embodiments, memory sharing can be realized by remapping a group of consecutive virtual addresses in linear memory address spaces of different Wasm programs to a shared data area. For example, a first Wasm program expects to share a memory area Region_A in its linear memory address space with a second Wasm program and a third Wasm program. The second Wasm program and the third Wasm program may map an unused virtual address space in their respective linear memory address spaces that satisfies a length of the shared memory to the physical memory area corresponding to Region_A. Therefore, the memory sharing between Wasm programs may be realized by means of the memory remapping technology, thereby avoiding the additional system overhead caused by realizing data sharing through memory copying.

In recent years, in order to improve data security, the trusted execution environment technology has also been widely used in scenarios of virtual machine management and maintenance. The trusted execution environment technology constructs a security region in a central processing unit by means of software and hardware, which may provide an independent execution environment with confidentiality and integrity protection for programs running therein.

In some embodiments, the trusted execution environment may implement protection at a process level. Specifically, in the trusted execution environment, the program running codes and the confidential data may be maintained in a piece of encrypted isolated memory, and calculation is completed in the encrypted isolated memory. The whole calculation process is invisible to the outside, and even an operating system with a higher privilege level may not view the execution flows and the confidential data in the encrypted isolated memory.

In some embodiments, since the Wasm technology can implement more secure memory isolation and can well support a multi-language architecture, the Wasm technology may be applied to the trusted execution environment to more conveniently and quickly construct a lightweight trusted data sandbox by means of the Wasm technology. When the Wasm technology is applied to the trusted execution environment, the memory security feature of the Wasm technology restricts the that the Wasm program may not access an address space outside the sandbox, and an application programming interface supervised by the system must be called to access a system resources, which makes the Wasm program running in the trusted execution environment has an isolation protection of a two-way sandbox. In this way, privacy computing and cloud proxy computing scenarios based on the trusted execution environment may be effectively supported, and public cloud confidential computing services, such as function as a service (FaaS), may be established.

In some embodiments, a software-based fault isolation (S SFI) technology may enable multiple Wasm programs running in the same system not interfering and invisible to each other. In this solution, the system is required to set a continuous and independent linear memory address space for each Wasm program, and restrict each Wasm program to only access its own linear memory address space. However, the linear memory management mechanism leads to obvious lack of support for shared memory. Specifically, when the linear memory model is used, the memory sharing of multiple Wasm programs mainly depends on the memory remapping technology. However, the shared memory based on memory remapping is lack of universality, for example, the trusted execution environment in user mode may not be supported. This is because the trusted execution environment in user mode does not trust the page table managed by the operating system, so the operating system is not allowed to remap the memory pages of the trusted execution environment. In addition, the above memory management mechanism may implement fine-grained memory access control. In this case, the shared memory is usually set to be readable and writable, and may not limit a certain shared memory block to be read-only for some Wasm programs while being readable and writable for other Wasm programs.

More importantly, the security of the above memory management mechanism is not strong enough. Specifically, all areas in the shared memory of the Wasm program are readable and writable, and the read-only permission may not be configured separately, which results in that the existing page table may modify the constant variable of the Wasm program through buffer overflow attacks, thereby changing the program execution flow.

In order to solve at least part of the above problems, the present disclosure proposed a data processing solution based on a trusted execution environment. The solution includes: initializing a first program and a second program different from the first program in the trusted execution environment; allocating a first memory space and a second memory space to the first program and the second program respectively, where the first memory space is a linear memory address space and includes at least a first memory page; and where the second memory space is a linear memory address space and includes at least a second memory page, and the second memory page is different from the first memory page; mapping the first memory page of the first memory space to a first virtual memory page in a virtual address space of the trusted execution environment; and mapping the second memory page of the second memory space to the first virtual memory page in the virtual address space. In this way, the shared memory can be realized between linear memory address spaces isolated from each other.

### Example Environment

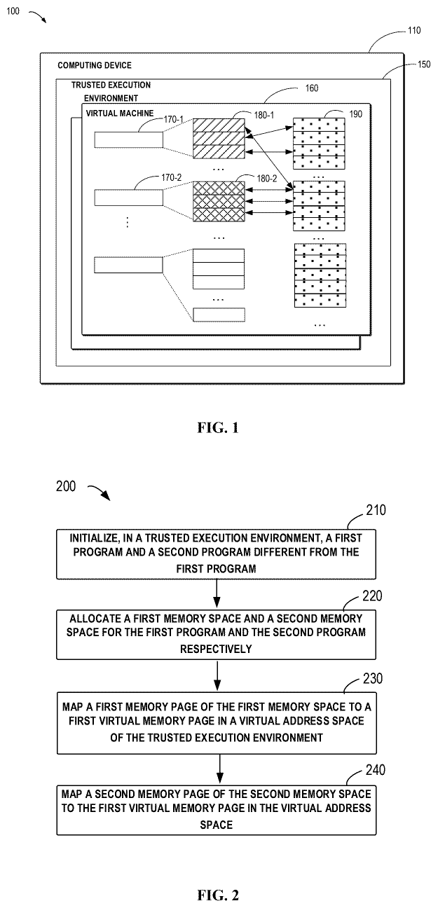

FIG. 1 illustrates a schematic diagram of an example environment 100 in which embodiments of the present disclosure can be implemented. As shown in FIG. 1, the example environment 100 may include a computing device 110. As shown in FIG. 1, the computing device 110 may be deployed with a trusted execution environment 150. One or more virtual machines 160 may run in the trusted execution environment 150.

Multiple programs may run on the virtual machine 160, such as a first program 170-1 and a second program 170-2 as shown in FIG. 1. For ease of discussion, the first program 170-1 and the second program 170-2 may be collectively referred to as a program 170.

An example of the program 170 is a Wasm program, and an example of the trusted execution environment 150 is a trusted execution environment based on user mode, such as a trusted execution environment based on software guard extensions (SGX).

The Wasm program has three running modes: an interpreter, ahead-of-time (AOT), and just-in-time (JIT). When the Wasm runs in the interpreter mode, Wasm instructions need to be interpreted one by one, and corresponding operations are executed on the virtual machine 160. When Wasm runs in the AOT mode, the Wasm bytecode may be converted into machine code in advance by means of a compilation step similar to a C++ program. The pre-compiled Wasm program is not an executable file that can be directly run, and needs to be loaded at runtime. When Wasm runs in the JIT mode, it is still interpreted and executed as a whole, but codes that are run frequently will be compiled to generate machine code to accelerate the running.

Further, when the program 170 is running, it may be allocated with linear memory address spaces isolated from each other. Each linear memory address space may include multiple memory pages, and at least some of the multiple memory pages may be mapped to virtual memory pages in the virtual address space 190. As shown in FIG. 1, the first program 170-1 is allocated with a first memory space 180-1, and the second program 170-2 is allocated with a second memory space 180-2.

Next, an address mapping mechanism of the Wasm program will be described by taking the ahead-of-time mode as an example,. When the Wasm program is executed, a 32-bit address may be used to access a 64-bit virtual memory address. Further, the Wasm program may only see the 32-bit address, and such an address is referred to as a Wasm address/program address, of which the range is [0, 4294967296], where 4294967296 is the maximum value of a 32-bit unsigned integer. When the Wasm program is running, the Wasm address needs to be converted into a virtual memory address. The address translation process from the Wasm address to the virtual address is described below.

In some embodiments, when the Wasm program is running, it will be allocated with linear virtual memory with a size of SIZE_{Mem}. This continuous linear virtual memory is represented as [ADDR_{Mem}, ADDR_{Mem}+SIZE_{Mem}], where ADDR_{Mem} is the start virtual memory address of the linear virtual memory. When the Wasm program accesses the linear memory, the mapping from the Wasm address ADDR_{Wasm} to the virtual address ADDR_{Virt} is ADDR_{Virt}=ADDR_{Wasm}+ADDR_{Mem}.

Since the Wasm program uses the continuous virtual address as the linear memory of the Wasm program when running, the whole translation process only needs to add the Wasm address and the start address of the linear memory, and the address translation process becomes very concise.

In some embodiments, the computing device 110 may be any type of mobile terminal, stationary terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices, or any combination thereof. In some embodiments, the client device 120 can also support any type of interface for users (such as “wearable” circuits, etc.).

Alternatively, in some embodiments, the computing device 110 may be an independent physical server, or a server cluster or a distributed system composed of a plurality of physical servers, or a cloud server that provides basic cloud computing services such as cloud services, cloud databases, cloud computing, cloud functions, cloud storage, network services, cloud communication, middleware services, domain name services, security services, content delivery networks, and big data and artificial intelligence platforms. The computing device 110 may include, for example, a computing system/server, such as a mainframe, an edge computing node, a computing device in a cloud environment, and the like.

It should be understood that the structure and function of the elements in the environment 100 are described for exemplary purposes only, without implying any limitation to the scope of the present disclosure. In other words, the structure, function, number, and linking relationship of the elements in the environment 100 may change according to actual needs. The present disclosure is not limited in this respect.

### Example Method

FIG. 2 illustrates a flowchart of a data processing process 200 according to some embodiments of the present disclosure. For ease of discussion, reference is made to the environment 100 of FIG. 1 for discussion. The data processing process 200 can be implemented at the computing device 110. Further, when the program 170 is a Wasm program, the process 200 may be executed by “Wasm runtime”.

In the following example embodiments, the Wasm program will be used as an example of the first program 170-1/the second program 170-2, and the trusted execution environment based on software guard extensions (SGX) will be used as an example of the trusted execution environment 150. It should be understood that the above examples may not be understood as limiting the protection scope of the present disclosure. In other embodiments, the first program 170-1/the second program 170-2 may be other instruction programs with good isolation, and the trusted execution environment 150 may be other trusted execution environments in user mode. The protection scope of the present disclosure is not limited in this respect.

In some embodiments, the second memory space 180-2 and the first memory space 180-1 are isolated from each other. In addition, the first memory space 180-1 is invisible to the second program 170-2, and the second memory space 180-2 is invisible to the first program 170-1.

At block 210, in the trusted execution environment 150, the computing device 110 initializes the first program 170-1 and the second program 170-2.

At block 220, the computing device 110 allocates the first memory space 180-1 and the second memory space 180-2 to the first program 170-1 and the second program 170-2 respectively.

In some embodiments, the first memory space 180-1 is a linear memory address space and includes at least a first memory page.

In some embodiments, the second memory space 180-2 is a linear memory address space and includes at least a second memory page, and the second memory page is different from the first memory page.

At block 230, the computing device 110 maps the first memory page of the first memory space 180-1 to a first virtual memory page in the virtual address space 190 of the trusted execution environment.

At block 240, the computing device 110 maps the second memory page of the second memory space 180-2 to the first virtual memory page in the virtual address space 190.

It can be seen that by dividing the linear memory address space allocated to the program 170 in units of memory pages and mapping it to the virtual memory pages in units of memory pages, a memory management and maintenance mechanism based on paging may be established in the trusted execution environment. In this way, the shared memory may be realized between the linear memory address spaces isolated from each other.

In some embodiments, the first memory space 180-1 further includes a third memory page and a fourth memory page, where the third memory page and the fourth memory page are two consecutive memory pages in the first memory space 180-1. The computing device 110 maps the third memory page of the first memory space 180-1 to a second virtual memory page in the virtual address space 190, and maps the fourth memory page of the first memory space 180-1 to a third virtual memory page in the virtual address space 190, where the second virtual memory page and the third virtual memory page are not consecutive in the virtual address space 190.

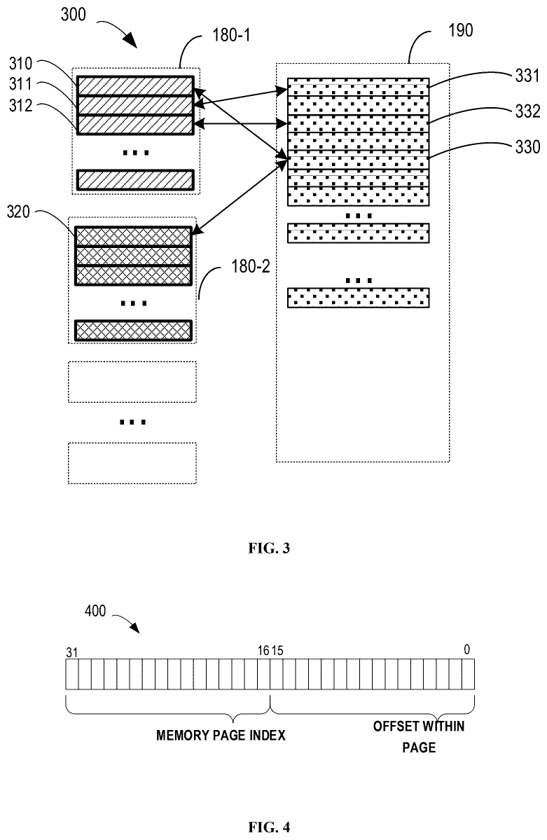

Reference is made to FIG. 3 for a better understanding of the above process, where FIG. 3 illustrates a block diagram of memory mapping 300 according to some embodiments of the present disclosure. For ease of discussion, reference is made to the environment 100 of FIG. 1 for discussion.

In the embodiment of FIG. 3, the first memory space 180-1 is allocated to the first program 170-1, which includes a first memory page 310, a third memory page 311, and a fourth memory page 312, etc. The second memory space 180-2 is allocated to the first program 170-2, which includes a second memory page 320, etc.

The computing device 110 is responsible for maintaining the virtual address space 190, and the virtual address space 190 includes a first virtual memory page 330, a second virtual memory page 331, a third virtual memory page 332, etc. When the first program 170-1 (or the second program 170-2) needs to use the first memory space 180-1/the second memory space 180-2, the computing device 110 is responsible for establishing/maintaining/interpreting the mapping from the first memory space 180-1/the second memory space 180-2 to the virtual address space 190.

As shown in FIG. 3, both the first memory page 310 of the first program 170-1 and the second memory page 320 of the second program 170-2 are mapped to the first virtual memory page 330. In other words, according to some embodiments of the present disclosure, the shared memory may be realized by modifying the address mapping/translation process.

Further, in the specific embodiment of FIG. 3, the first memory page 310 and the second memory page 320 may be referred to as shared memory pages; since the third memory page 311 and the fourth memory page 312 are not shared with other programs, the third memory page 311 and the fourth memory page 312 may also be referred to as private memory pages of the first program 170-1.

In FIG. 3, the third memory page 311 and the fourth memory page are consecutive in the first memory space 180-1. In an operation, the third memory page 311 and the fourth memory page are mapped to the second virtual memory page 331 and the third virtual memory page 332 respectively.

In this way, consecutive memory pages in the linear memory address space may be mapped to non-consecutive virtual memory pages in the virtual address space 190 in a non-linear manner. In this way, the manner of memory mapping will be more flexible.

According to some embodiments of the present disclosure, the memory pages in the system may be managed and maintained by means of a page table. Next, how to design and maintain the page table will be described in conjunction with example embodiments.

In some embodiments, the memory size of the linear memory address space may be set to an integer multiple of a predetermined memory block. For example, when the program 170 is a Wasm program, the size of the linear memory address space allocated to the program 170 may be an integer multiple of 65,536 bytes (i.e., 64 KB).

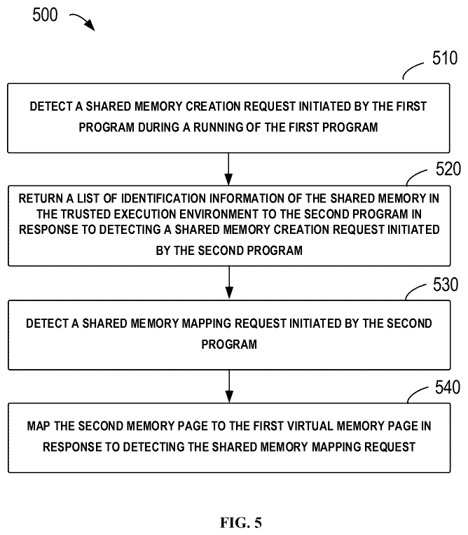

Referring to FIG. 4, it illustrates a block diagram of program addresses 400 according to some embodiments of the present disclosure. In the specific embodiment of FIG. 4, the size of each memory page is 64 KB, then for a 32-bit program address, the high/low 16 bits may be used as a memory page index, and the low/high 16 bits may be used as an offset within the page.

In some embodiments, the computing device 110 may generate a first mapping table for the first program 170-1, where the first mapping table includes at least one page table entry. Further, each page table entry corresponds to a respective memory page in the first memory space 180-1 and indicates at least one of the following: whether the respective memory page has been mapped to a virtual memory page in the virtual address space 190, or virtual address information of the virtual memory page corresponding to the respective memory page in the virtual address space 190.

Continuing to refer to FIG. 3, in FIG. 3, the first mapping table may include a first page table entry corresponding to the first memory page 310, where the first page table entry includes at least one of: first information indicating that the first memory page 310 has been mapped to the first virtual memory page 330, and second information indicating a first virtual address identifying the first virtual memory page 330.

In the example embodiments where the program 170 is a Wasm program, the mapping relationship between the Wasm address and the virtual address of the Wasm program may be stored in the page table, that is, the mapping relationship between the memory page information of the Wasm program and the virtual memory page is stored.

Further, in a case where the maximum memory allocated to the Wasm program is 4 G and each memory page is 64 KB, each Wasm program may be allocated with at most 65,536 memory pages (because 64 KB*65,536=4 GB). In this case, each page table may include at most 65,536 page table entries, and each page table entry stores information corresponding to one memory page. In some embodiments, each page table entry may include first information, which may be a Boolean value, indicating whether the Wasm memory page has been bound to a virtual memory page or whether the start address of the Wasm memory page has been bound to the start address of a virtual memory page. If a Wasm memory page has been bound to a virtual memory page, the first information is true, and the corresponding page table entry may be called a mapped page table entry. Correspondingly, if a Wasm memory page has not been bound to a virtual memory page, the first information is false, and the corresponding page table entry may be called an unmapped page table entry. Alternatively, each page table entry may also include second information, which indicates the start address of the virtual memory page to which the Wasm memory page is bound when the first information is true/a Wasm memory page has been bound to a virtual memory page.

In this way, the mapping relationship of the memory pages may be maintained separately through the page table, which reduces the cost of memory page maintenance and improves the efficiency of memory page maintenance.

Further, dynamic memory allocation may be realized by dynamically modifying the page table. Specifically, when the computing device 110 loads a program 170, a page table will be created for the program, and during the execution process, at least one page table entry in the page table can be dynamically modified, that is, an unmapped memory page is mapped to the corresponding virtual memory page.

In some embodiments, in response to the first program 170-1 being executed, the computing device 110 generates a first mapping table for the first program 170-1, where the first mapping table has a preset number of page table entries, for example, equal to (or less than) 65,536 page table entries.

Further, in response to detecting an instruction for increasing memory for the first program 170-1, the computing device 110 modifies at least one page table entry in the first mapping table to indicate a mapping relationship between at least one newly allocated memory page in the first memory space 180-1 and at least one virtual memory page in the virtual address space 190.

Additionally, before the program 170 is released, the program 170 may be allowed to release a mapping that has been established before. For example, the program 170 may call a mapping release interface provided by the system to release some memory page mappings according to the requirements of the program 170.

The Wasm program is taken as an example for further description. The bytecode of the Wasm program specifies its initial memory size and maximum memory size. Therefore, when creating the page table, the computing device 110 may first map some Wasm pages to a virtual memory page to meet the initial memory size requirement of the program, for example, the computing device creates a page table with 65,536 page table entries, and modify 4,096 of them to mapped entries.

If the Wasm program has a memory growth requirement subsequently, more mappings are established through a Wasm memory growth instruction to realize memory expansion, that is, by modifying unmapped page table entries to mapped page table entries. Correspondingly, before the Wasm program is released, the Wasm program may also call a system instruction to release the mapped page table entries.

In this way, the memory of the system may be allocated on demand according to requirements, and may be released in time when not needed, thereby improving the utilization of system resources.

According to some embodiments of the present disclosure, different memory pages may be configured with different read and write permissions. When the memory page is a shared memory page, the security of data management may be effectively improved.

In some embodiments, the first mapping table includes a first sub-mapping table and/or a second sub-mapping table. The first sub-mapping table includes at least one first page table entry, and the at least one first page table entry corresponds to at least one memory page with which the first program 170-1 has read-only permission. Correspondingly, the second sub-mapping table includes at least one second page table entry, and the at least one second page table entry corresponds to at least one memory page with which the first program 170-1 has write permission.

In other embodiments that implement read and write permission control of memory pages, in addition to the first information and the second information, each page table entry may also include third information, where the third information indicates read and write permission information of a corresponding program for a memory page corresponding to the page table entry.

The embodiments of read and write permission control are still described by taking the Wasm program as an example. In some embodiments, when multiple Wasm programs share memory with each other, it is necessary to limit the write permission of the shared memory to prevent unrelated programs from modifying the shared memory.

However, the conventional scheme cannot implement read and write control over the shared memory. Specifically, in the conventional scheme, permission control takes effect for all Wasm programs. Therefore, in the conventional scheme, when a Wasm program obtains access permission to a piece of shared memory, it also has read and write permissions. Under such a limitation, a Wasm program may not limit another Wasm program to only read the shared memory, because in the conventional scheme, if a shared memory page is set to be read-only, all Wasm programs in the system cannot obtain the write permission.

According to the paging-based memory management and maintenance mechanism of the present disclosure, the memory access control can be optimized by setting up a read page table (i.e., the first sub-mapping table) and a write page table (i.e., the second sub-mapping table). Specifically, the computing device 110 maintains two single-level page tables for each Wasm program, that is, a read page table and a write page table. The read page table records address mappings with which the program has read-only permission, and the write page table records address mappings with which the program has write permission. When the Wasm program executes a memory read instruction, the read page table is used for address translation, and when the Wasm program writes to the memory, the write page table is used for address translation. In this way, a Wasm program may implement read/write access control over different memory pages.

According to the paging-based memory management and maintenance mechanism of the present disclosure, the mapping relationship from the program address to the virtual address can also be modified at the granularity of memory pages, so that the shared memory across programs can be conveniently realized. Next, the creation of the shared memory across programs will be further described with reference to FIG. 5. FIG. 5 illustrates a flowchart of a shared memory mapping method 500 according to some embodiments of the present disclosure. In the embodiment of FIG. 5, the computing device 110 has mapped the first memory page to the first virtual memory page.

At block 510, during the running of the first program, the computing device 110 detects a shared memory creation request initiated by the first program 170-1, where the shared memory creation request indicates first memory address information of the first memory page, read and write permission information set by the first program for the first memory page, and first identification information of the first memory page.

At block 520, in response to detecting a shared memory query request initiated by the second program 170-2, the computing device 110 returns a list of identification information of the shared memory to the second program 170-2, where the list of identification information includes the first identification information of the first memory page.

At block 530, the computing device 110 detects a shared memory mapping request initiated by the second program 170-2, where the shared memory mapping request indicates second memory address information of the second memory page and the first identification information of the first memory page.

At block 540, in response to detecting the shared memory mapping request, the computing device 110 maps the second memory page to the first virtual memory page.

The description is still made by taking the Wasm program as an example. In some embodiments, the first Wasm program may call a preset function to create a shared memory page, and input parameters of the preset function may include: 1) information indicating a piece of shared memory that the first Wasm program desires to share; 2) information indicating an access control policy of the shared region, that is, read and write permissions of other Wasm programs to the region; and 3) an identification for identifying the piece of shared memory. As an example, the first Wasm program desires to share the first memory page, and restricts other Wasm programs from modifying the content of the first memory page, and sets the identification of the first memory page to “1”.

The second Wasm program may send a shared memory query request. The computing device 110 returns a list to the second Wasm program, where the list listed the identification of the existing shared memory region, for example, the identification “1” of the first memory page.

The second Wasm program may remap a memory area in its linear memory address space to the corresponding shared memory by sending a shared memory mapping request. For example, if the second Wasm program desires to map its second memory page to the first memory page of the first Wasm program, the second Wasm program sends a shared memory mapping request indicating the address of the second memory page and the identification “1” of the first memory page. The computing device 110 may map the second memory page to the first virtual memory page, that is, the virtual memory page corresponding to the first memory page.

In this way, the memory sharing may be conveniently and quickly realized without introducing excessive overhead, and different Wasm programs may be implemented with different read and write permission control.

In addition, in order to further improve the security of data, the computing device 110 may set a boundary check rule to avoid out-of-bounds access of the program 170. Specifically, the computing device 110 performs a boundary check for each access to the linear memory address space to ensure that a program may only access its own linear memory address space.

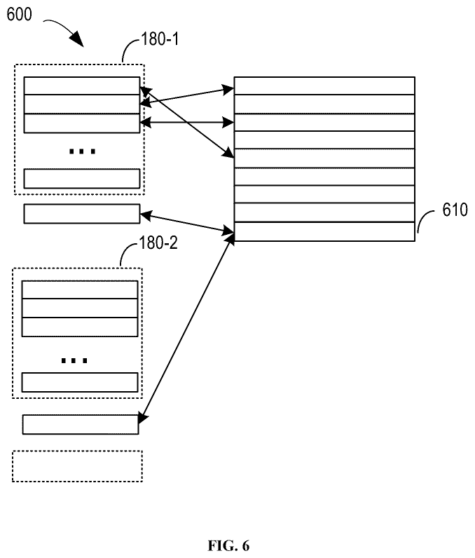

In the paging memory management mode, an exception memory page may be used to assist in implementing boundary checking. Reference is made to FIG. 6, which illustrates a block diagram of another memory mapping 600 according to some embodiments of the present disclosure.

In some embodiments, the computing device 110 detects a data access request initiated by the first program 170-1. In response to detecting the data access request initiated by the first program 170-1, the computing device 110 determines whether the memory address corresponding to the data is within the first memory space 180-1, and if the memory address is not within the first memory space 180-1, maps the memory address to an exception virtual memory page 610 in the virtual address space 190.

Taking the Wasm program as an example, the computing device 110 may separately maintain a 64 KB memory area for each Wasm program, which is called an exception memory page. In some embodiments, the computing device 110 modifies the address of the virtual memory page in the unmapped page table entry to a virtual memory address pointing to the exception memory page in advance. Therefore, when the Wasm program accesses the unmapped memory page, it actually accesses its own exception memory page.

In this way, in the case that the memory access is legal, the exception memory page will never be accessed, and the exception memory page will only be accessed when the memory is out-of-bounds. Since the exception memory page does not store any meaningful information, only the exception memory page can be accessed during out-of-bounds access without affecting the original sandbox design of Wasm.

According to some embodiments of the present disclosure, a paging memory management method is proposed, which is especially suitable for a Wasm-based SGX environment. The paging memory management of the present disclosure can effectively solve the disadvantages of the linear memory model that the shared memory support is insufficient and the read-only permission may not be flexibly set.

In addition, according to the paging-based memory management and maintenance mechanism of the present disclosure, the virtual address corresponding to the linear memory of the Wasm program may be discontinuous, and dynamic increase or decrease of the linear memory by establishing or canceling the corresponding mapping on the page table is supported.

More importantly, the shared memory solution implemented according to the paging-based memory management and maintenance mechanism of the present disclosure is more versatile (applicable to various types of trusted execution environments including SGX), and flexible read and write permission control over the shared memory region can be realized among multiple programs.

### Example Apparatus and Device

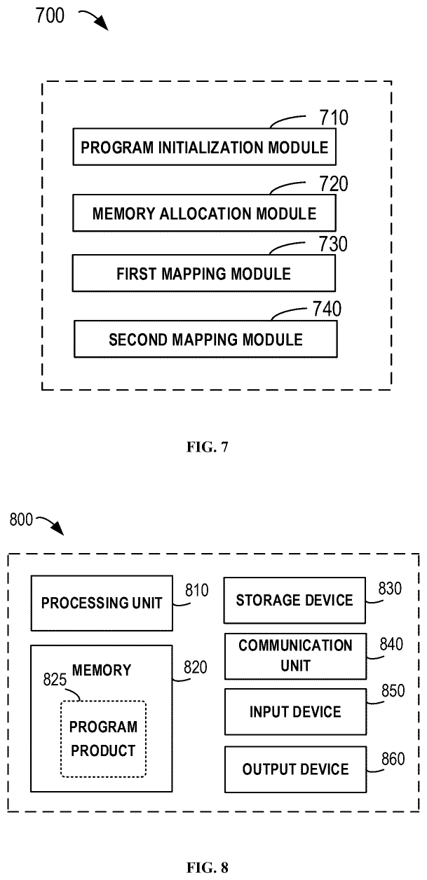

FIG. 7 illustrates a schematic structural block diagram of a data processing apparatus 700 according to some embodiments of the present disclosure. The apparatus 700 may be implemented as or included in the computing device 110. Various modules/components in the apparatus 700 may be implemented by hardware, software, firmware, or any combination thereof.

As shown in FIG. 7, the apparatus 700 includes: a program initialization module 710 configured to initialize a first program and a second program different from the first program in a trusted execution environment; a memory allocation module 720 configured to allocate a first memory space and a second memory space to the first program and the second program respectively, where the first memory space is visible to the first program and invisible to the second program, and the second memory space is visible to the second program and invisible to the first program; where the first memory space is a linear memory address space and includes at least a first memory page; and where the second memory space is a linear memory address space and includes at least a second memory page, and the second memory page is different from the first memory page; a first mapping module 730 configured to map the first memory page of the first memory space to a first virtual memory page in a virtual address space of the trusted execution environment; and a second mapping module 740 configured to map the second memory page of the second memory space to the first virtual memory page in the virtual address space.

In some embodiments, the apparatus 700 further includes an out-of-bounds checking module configured to determine whether a memory address corresponding to data is within the first memory space in response to detecting an access request of the data initiated by the first program; and map the memory address to an exception virtual memory page in the virtual address space in accordance with a determination that the memory address is not within the first memory space.

In some embodiments, the apparatus 700 further includes: a page table generation module configured to generate a first mapping table for the first program, where the first mapping table includes at least one page table entry, each page table entry corresponding to a respective memory page in the first memory space and indicating at least one of: whether the respective memory page has been mapped to a virtual memory page in the virtual address space, or virtual address information of the virtual memory page corresponding to the respective memory page in the virtual address space.

In some embodiments, the page table generation module is further configured to: generate the first mapping table for the first program in response to detecting that the first program is initialized, where the first mapping table has a preset number of page table entries. The apparatus 700 further includes: a memory modification module configured to modify at least one page table entry in the first mapping table to indicate a mapping relationship between at least one newly allocated memory page in the first memory space and at least one virtual memory page in the virtual address space in response to detecting an instruction for increasing memory for the first program.

In some embodiments, the first mapping table includes a first page table entry corresponding to the first memory page, where the first page table entry includes at least one of: first information indicating that the first memory page has been mapped to the first virtual memory page, second information indicating a first virtual address identifying the first virtual memory page, and third information indicating read and write permission information for the first memory page of the first program.

In some embodiments, the first mapping table includes at least one of: a first sub-mapping table, where the first sub-mapping table includes at least one first page table entry, and the at least one first page table entry corresponds to at least one memory page with which the first program has read-only permission; or a second sub-mapping table, where the second sub-mapping table includes at least one second page table entry, and the at least one second page table entry corresponds to at least one memory page with which the first program has write permission.

In some embodiments, the first memory space further includes a third memory page and a fourth memory page, where the third memory page and the fourth memory page are two consecutive memory pages in the first memory space, and the apparatus 700 further includes: a second mapping module configured to map the third memory page to a second virtual memory page in the virtual address space; and a third mapping module configured to map the fourth memory page to a third virtual memory page in the virtual address space, where the second virtual memory page and the third virtual memory page are not consecutive in the virtual address space.

In some embodiments, the apparatus 700 further includes: a shared request detection module configured to detect a shared memory creation request initiated by the first program during the running of the first program, where the shared memory creation request indicates first memory address information of the first memory page, read and write permission information set by the first program for the first memory page, and first identification information of the first memory page; a shared memory query request processing module configured to return a list of identification information of the shared memory in the trusted execution environment to the second program in response to detecting a shared memory query request initiated by the second program, where the list of identification information includes the first identification information of the first memory page; a shared memory mapping request processing module configured to detect a shared memory mapping request initiated by the second program, where the shared memory mapping request indicates second memory address information of the second memory page and the first identification information of the first memory page; and a shared memory mapping module configured to map the second memory page to the first virtual memory page in response to detecting the shared memory mapping request.

FIG. 8 illustrates a block diagram of an electronic device 800 in which one or more embodiments of the present disclosure can be implemented. It should be understood that the electronic device 800 shown in FIG. 8 is only exemplary and should not constitute any limitation to the function and scope of the embodiments described herein. The electronic device 800 shown in FIG. 8 can be used to implement the computing device 110 of FIG. 1.

As shown in FIG. 8, the electronic device 800 is in the form of a general electronic device or a computing device. The components of the electronic device 800 may include, but are not limited to, one or more processors or processing units 810, a memory 820, a storage device 830, one or more communication units 840, one or more input devices 850, and one or more output devices 860. The processing unit 810 may be a physical or virtual processor and can perform various processes according to programs stored in the memory 820. In a multi-processor system, multiple processing units execute computer-executable instructions in parallel to improve the parallel processing capability of the electronic device 800.

The electronic device 800 usually includes multiple computer storage media. Such media may be any available media accessible to the electronic device 800, including but not limited to volatile and non-volatile media, removable and non-removable media. The memory 820 may be a volatile memory (such as a register, a cache, and a random access memory (RAM)), a non-volatile memory (such as a read-only memory (ROM), an electrically erasable programmable read-only memory (EEPROM), and a flash memory), or some combination thereof. The storage device 830 may be a removable or non-removable medium, and may include a machine-readable medium, such as a flash drive, a magnetic disk, or any other medium, which may be used to store information and/or data (such as training data for training) and may be accessed within the electronic device 800.

The electronic device 800 may further include additional removable/non-removable, volatile/non-volatile storage media. Although not shown in FIG. 8, a magnetic disk drive for reading from or writing to a removable, non-volatile magnetic disk (e.g., a “floppy disk”) and an optical disk drive for reading from or writing to a removable, non-volatile optical disk may be provided. In these cases, each drive may be connected to a bus (not shown) by one or more data medium interfaces. The memory 820 may include a computer program product 825 having one or more program modules configured to execute various methods or actions of various embodiments of the present disclosure.

The communication unit 840 implements communication with other electronic devices through a communication medium. Additionally, the functions of the components of the electronic device 800 may be implemented by a single computing cluster or multiple computing machines that can communicate over a communication connection. Therefore, the electronic device 800 may operate in a networked environment using a logical connection to one or more other servers, network personal computers (PCs), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required, such as a storage device, a display device, etc., communicate with one or more devices that enable a user to interact with the electronic device 800, or communicate with any device (such as a network card, a modem, etc.) that enables the electronic device 800 to communicate with one or more other electronic devices. Such communication may be performed via an input/output (I/O) interface (not shown).

According to an exemplary implementation of the present disclosure, a computer-readable storage medium is provided, on which computer-executable instructions are stored, where the computer-executable instructions are executed by a processor to implement the above-described method. According to an exemplary implementation of the present disclosure, a computer program product is further provided, which is tangibly stored on a non-transitory computer-readable medium and includes computer-executable instructions, and the computer-executable instructions are executed by a processor to implement the above-described method.

Various aspects of the present disclosure are described herein with reference to flowcharts and/or block diagrams of methods, apparatuses, devices and computer program products implemented according to the present disclosure. It should be understood that each block of the flowcharts and/or block diagrams and combinations of blocks in the flowcharts and/or block diagrams can be implemented by computer-readable program instructions.

These computer-readable program instructions can be provided to the processing unit of a general-purpose computer, a special-purpose computer, or other programmable data processing apparatus to produce a machine, so that these instructions, when executed by the processing unit of the computer or other programmable data processing apparatus, produce an apparatus for implementing the functions/actions specified in one or more blocks of the flowcharts and/or block diagrams. These computer-readable program instructions can also be stored in a computer-readable storage medium. These instructions enable the computer, the programmable data processing apparatus, and/or other devices to work in a specific manner. Therefore, the computer-readable medium storing the instructions includes an article of manufacture, which includes instructions for implementing various aspects of the functions/actions specified in one or more blocks of the flowcharts and/or block diagrams.

The computer-readable program instructions can be loaded onto the computer, other programmable data processing apparatus, or other device, so that a series of operation steps are executed on the computer, other programmable data processing apparatus, or other device to produce a computer-implemented process, thereby causing the instructions executed on the computer, other programmable data processing apparatus, or other device to implement the functions/actions specified in one or more blocks of the flowcharts and/or block diagrams.

The flowcharts and block diagrams in the drawings show the architecture, functionality, and operation of possible implementations of systems, methods, and computer program products according to multiple implementations of the present disclosure. In this regard, each block in the flowcharts or block diagrams may represent a module, a program segment, or a part of instructions, and the module, the program segment, or the part of instructions contains one or more executable instructions for implementing specified logical functions. In some alternative implementations, the functions noted in the blocks may also occur in an order different from those noted in the drawings. For example, two consecutive blocks may, in fact, be executed substantially concurrently, or the blocks may sometimes be executed in a reverse order, depending on the functionality involved. It should also be noted that each block of the block diagrams and/or flowcharts and combinations of blocks in the block diagrams and/or flowcharts may be implemented by a dedicated hardware-based system that performs the specified functions or actions, or may be implemented by a combination of dedicated hardware and computer instructions.

Various implementations of the present disclosure have been described above, and the above description is exemplary and not exhaustive, and is not limited to the disclosed implementations. Many modifications and variations will be apparent to those skilled in the art without departing from the scope and spirit of the described implementations. The terminology used herein is chosen to best explain the principles, practical applications, or improvements of the implementations in the market, or to enable other ordinary skilled in the art to understand the implementations disclosed herein.

1. A method for data processing, comprising:
initializing, in a trusted execution environment, a first program and a second program different from the first program;
allocating a first memory space and a second memory space to the first program and the second program respectively;
wherein the first memory space is visible to the first program and invisible to the second program, and the second memory space is visible to the second program and invisible to the first program;
wherein the first memory space is a linear memory address space and comprises at least a first memory page; and
wherein the second memory space is a linear memory address space and comprises at least a second memory page, the second memory page being different from the first memory page;
mapping the first memory page of the first memory space to a first virtual memory page in a virtual address space of the trusted execution environment; and
mapping the second memory page of the second memory space to the first virtual memory page in the virtual address space.

2. The method according to claim 1, further comprising:
determining whether a memory address corresponding to data is within the first memory space in response to detecting an access request of the data initiated by the first program; and
mapping the memory address to an exception virtual memory page in the virtual address space in accordance with a determination that the memory address is not within the first memory space.

3. The method according to claim 1, further comprising:
generating a first mapping table for the first program, wherein the first mapping table comprises at least one page table entry, each page table entry corresponding to a respective memory page in the first memory space and indicating at least one of:
whether the respective memory page has been mapped to a virtual memory page in the virtual address space, or
virtual address information of a virtual memory page corresponding to the respective memory page in the virtual address space.

4. The method according to claim 3, wherein generating the first mapping table for the first program comprises:
generating the first mapping table for the first program in response to detecting that the first program is initialized, wherein the first mapping table has a preset number of page table entries; and
the method further comprises:
modifying at least one page table entry in the first mapping table to indicate a mapping relationship between at least one newly allocated memory page in the first memory space and at least one virtual memory page in the virtual address space in response to detecting an instruction for increasing memory for the first program.

5. The method according to claim 3, wherein the first mapping table comprises a first page table entry corresponding to the first memory page, the first page table entry comprising at least one of:
first information indicating that the first memory page has been mapped to a first virtual memory page;
second information indicating a first virtual address identifying the first virtual memory page; or
third information indicating read and write permission information for the first memory page of the first program.

6. The method according to claim 3, wherein the first mapping table comprises at least one of:
a first sub-mapping table, wherein the first sub-mapping table comprises at least one first page table entry, and the at least one first page table entry corresponds to at least one memory page for which the first program has read-only permission; or
a second sub-mapping table, wherein the second sub-mapping table comprises at least one second page table entry, and the at least one second page table entry corresponds to at least one memory page for which the first program has write permission.

7. The method according to claim 1, wherein the first memory space further comprises a third memory page and a fourth memory page, the third memory page and the fourth memory page being two consecutive memory pages in the first memory space, and the method further comprises:
mapping the third memory page of the first memory space to a second virtual memory page in the virtual address space; and
mapping the fourth memory page to a third virtual memory page in the virtual address space, the second virtual memory page and the third virtual memory page being not consecutive in the virtual address space.

8. The method according to claim 1, further comprising:
detecting a shared memory creation request initiated by the first program during a running of the first program, the shared memory creation request indicating first memory address information of the first memory page, read and write permission information for the first memory page set by the first program, and first identification information of the first memory page;
returning a list of identification information of the shared memory in the trusted execution environment to the second program in response to detecting a shared memory query request initiated by the second program, the list of identification information comprising the first identification information of the first memory page;
detecting a shared memory mapping request initiated by the second program, the shared memory mapping request indicating second memory address information of the second memory page and the first identification information of the first memory page; and
mapping the second memory page to the first virtual memory page in response to detecting the shared memory mapping request.

9-16. (canceled)

17. An electronic device, comprising:
at least one processor; and
at least one memory, the at least one memory coupled to the at least one processor and storing instructions for execution by the at least one processor, the instructions, when executed by the at least one processor, causing the electronic device to perform operations comprising:
initializing, in a trusted execution environment, a first program and a second program different from the first program;
allocating a first memory space and a second memory space to the first program and the second program respectively;
wherein the first memory space is visible to the first program and invisible to the second program, and the second memory space is visible to the second program and invisible to the first program;
wherein the first memory space is a linear memory address space and comprises at least a first memory page; and
wherein the second memory space is a linear memory address space and comprises at least a second memory page, the second memory page being different from the first memory page;
mapping the first memory page of the first memory space to a first virtual memory page in a virtual address space of the trusted execution environment; and
mapping the second memory page of the second memory space to the first virtual memory page in the virtual address space.

18. A non-transitory computer-readable storage medium having a computer program stored thereon, the computer program, when executed by a processor, implementing the operations comprising
initializing, in a trusted execution environment, a first program and a second program different from the first program;
allocating a first memory space and a second memory space to the first program and the second program respectively;
wherein the first memory space is visible to the first program and invisible to the second program, and the second memory space is visible to the second program and invisible to the first program;
wherein the first memory space is a linear memory address space and comprises at least a first memory page; and
wherein the second memory space is a linear memory address space and comprises at least a second memory page, the second memory page being different from the first memory page;
mapping the first memory page of the first memory space to a first virtual memory page in a virtual address space of the trusted execution environment; and
mapping the second memory page of the second memory space to the first virtual memory page in the virtual address space.

19. The electronic device according to claim 17, the operations further comprising:
determining whether a memory address corresponding to data is within the first memory space in response to detecting an access request of the data initiated by the first program; and
mapping the memory address to an exception virtual memory page in the virtual address space in accordance with a determination that the memory address is not within the first memory space.

20. The electronic device according to claim 17, the operations further comprising:
generating a first mapping table for the first program, wherein the first mapping table comprises at least one page table entry, each page table entry corresponding to a respective memory page in the first memory space and indicating at least one of:
whether the respective memory page has been mapped to a virtual memory page in the virtual address space, or
virtual address information of a virtual memory page corresponding to the respective memory page in the virtual address space.

21. The electronic device according to claim 20, wherein generating the first mapping table for the first program comprises:
generating the first mapping table for the first program in response to detecting that the first program is initialized, wherein the first mapping table has a preset number of page table entries; and
the operations further comprises:
modifying at least one page table entry in the first mapping table to indicate a mapping relationship between at least one newly allocated memory page in the first memory space and at least one virtual memory page in the virtual address space in response to detecting an instruction for increasing memory for the first program.

22. The electronic device according to claim 20, wherein the first mapping table comprises a first page table entry corresponding to the first memory page, the first page table entry comprising at least one of:
first information indicating that the first memory page has been mapped to a first virtual memory page;
second information indicating a first virtual address identifying the first virtual memory page; or
third information indicating read and write permission information for the first memory page of the first program.

23. The electronic device according to claim 20, wherein the first mapping table comprises at least one of:
a first sub-mapping table, wherein the first sub-mapping table comprises at least one first page table entry, and the at least one first page table entry corresponds to at least one memory page for which the first program has read-only permission; or
a second sub-mapping table, wherein the second sub-mapping table comprises at least one second page table entry, and the at least one second page table entry corresponds to at least one memory page for which the first program has write permission.

24. The electronic device according to claim 17, wherein the first memory space further comprises a third memory page and a fourth memory page, the third memory page and the fourth memory page being two consecutive memory pages in the first memory space, and the operations further comprises:
mapping the third memory page of the first memory space to a second virtual memory page in the virtual address space; and
mapping the fourth memory page to a third virtual memory page in the virtual address space, the second virtual memory page and the third virtual memory page being not consecutive in the virtual address space

25. The electronic device according to claim 17, the operations further comprising:
detecting a shared memory creation request initiated by the first program during a running of the first program, the shared memory creation request indicating first memory address information of the first memory page, read and write permission information for the first memory page set by the first program, and first identification information of the first memory page;
returning a list of identification information of the shared memory in the trusted execution environment to the second program in response to detecting a shared memory query request initiated by the second program, the list of identification information comprising the first identification information of the first memory page;
detecting a shared memory mapping request initiated by the second program, the shared memory mapping request indicating second memory address information of the second memory page and the first identification information of the first memory page; and
mapping the second memory page to the first virtual memory page in response to detecting the shared memory mapping request.

26. The non-transitory computer-readable storage medium according to claim 18, the operations further comprising:
determining whether a memory address corresponding to data is within the first memory space in response to detecting an access request of the data initiated by the first program; and
mapping the memory address to an exception virtual memory page in the virtual address space in accordance with a determination that the memory address is not within the first memory space.

27. The non-transitory computer-readable storage medium according to claim 18, the operations further comprising:
generating a first mapping table for the first program, wherein the first mapping table comprises at least one page table entry, each page table entry corresponding to a respective memory page in the first memory space and indicating at least one of:
whether the respective memory page has been mapped to a virtual memory page in the virtual address space, or
virtual address information of a virtual memory page corresponding to the respective memory page in the virtual address space.

28. The non-transitory computer-readable storage medium according to claim 27, wherein generating the first mapping table for the first program comprises:
generating the first mapping table for the first program in response to detecting that the first program is initialized, wherein the first mapping table has a preset number of page table entries; and
the operations further comprises:
modifying at least one page table entry in the first mapping table to indicate a mapping relationship between at least one newly allocated memory page in the first memory space and at least one virtual memory page in the virtual address space in response to detecting an instruction for increasing memory for the first program.

29. The non-transitory computer-readable storage medium according to claim 27, wherein the first mapping table comprises a first page table entry corresponding to the first memory page, the first page table entry comprising at least one of:
first information indicating that the first memory page has been mapped to a first virtual memory page;
second information indicating a first virtual address identifying the first virtual memory page; or
third information indicating read and write permission information for the first memory page of the first program.
